(19) United States
(12) Patent Application Publication
(10) Pub. No.: US 2008/0232468 A1
(43) Pub. Date: Sep. 25, 2008

(54) METHOD AND APPARATUS FOR ADAPTIVE GOP STRUCTURE DETERMINATION

(75) Inventors: Do Kyoung Kwon, Kyunggi (KR); Meiyin Shen, Kaohsiung City (TW); Chung-Chieh Kuo, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/688,918

(22) Filed: Mar. 21, 2007

(51) Int. Cl. H04N 7/12

(52) U.S. Cl. 375/240.12

(57) ABSTRACT

A video encoder, determining a Group of Picture (GOP) structure and a method thereof. The video encoder comprises an input frame buffer, an I-frame module and a P-frame module. The input frame buffer receives and stores input frames. The I-frame module coupled to the input frame buffer identifies an I-frame based on a correlation between two consecutive input frames to obtain the GOP size. The P-frame module coupled to the input frame buffer and the I-frame module, determines P-frames in the GOP having the GOP size based on the GOP rate.

### BACKGROUND OF THE INVENTION

1. Field of the Invention

The present invention generally relates to video encoding, and in particular to a method and an apparatus for adaptive GOP structure determination.

2. Description of the Related Art

Block-based video coding standards such as MPEG-1/2/4 and H.26x define the bitstream syntax and the decoding process thereof, so that encoders conforming to the standards produce a bitstream decodable by other standard compliant decoders. Although not necessarily producing high video quality, the video coding standards provide flexibility for encoders to exploit optimization techniques to improve video quality.

One area of flexibility given to encoders is frame type. In block-based video encoders, three frame types can be encoded, namely I, P and B-frames. An I-frame is an intra-coded frame without any motion-compensated prediction (MCP). A P-frame is a predicted frame with MCP from previous reference frames and a B-frame is a bi-directionally predicted frame with MCP from previous and future reference frames. Generally, I and P-frames are used as reference for MCP. For simplicity, in most video coding applications, the frame type is determined in advance based on the characteristics of application. In conversational applications such as video conferencing where the input video is encoded and transmitted in real time, I-frames are placed at every fixed interval and all other frames are encoded as P-frames. In non-conversational applications such as video on storage media, e.g., DVD, where the input video can be encoded offline, a fixed group-of-picture (GOP) structure is employed.

A GOP structure comprises an I-frame followed by P and B-frames, and is characterized by distances between I-frames and P-frames, represented by parameters N and M respectively. In general, parameter N (the distance between I-frames) is fixed at 15 or 12 to facilitate random accessibility and the parameter M (the distance between P-frames) is selected according to application, such that a fixed number of B-frames, e.g., 1, 2 or 3 B-frames, are placed between two reference frames.

While fixed GOP structures are easy to implement, they prevent encoders from adapting to temporal variations in frames and thus prevent encoders from improving coding efficiency by selecting the frame type of each frame adaptively. For example, higher quality can be achieved by placing more B-frames for scenes with small motion and by placing more P-frames for scenes with large motion. To address this issue especially in non-conversational video applications, several solutions have been proposed for adaptive frame type decision, i.e., GOP structure decision.

The first effort to adapt frame types to temporal variations in frames was proposed by J. Lee and B. W. Dickinson, “Temporally adaptive motion interpolation exploiting temporal masking in visual perception,” IEEE Trans. Image Processing, vol. 3, pp. 513-526, September 1994, where the number of reference frames and intervals therebetween are adjusted according to the temporal variations in the input video for a fixed GOP size of 15 or 16. Several correlation-based distance metrics including difference of histogram (DOH), histogram of difference (HOD), block histogram difference (BH), block variance difference (BV), and motion compensation error (MCE) are used to adapt to temporal variations in frames. Rate control is also achieved by taking advantage of temporal masking in human vision using six different frame types, I1, I2, P1, P2, B1, and B2 for different bit allocations. For example, the first frame after abrupt scene change is encoded as a coarsely quantized I2 frame and the frame just before the I2 frame is encoded as a coarsely quantized P2 frame. When the distance between the current frame and the previous reference frame exceeds a threshold, a finely quantized P1 frame is set to avoid long distances between reference frames.

In “MPEG encoding algorithm with scene adaptive dynamic GOP structure,” IEEE 3rd Workshop MMSP, pp. 297-302, September 1999 by A. Yoneyama, Y. nakajima, H. Yanagihara, and M. Sugano and “One-pass VBR MPEG encoder using scene adaptive dynamic GOP structure,” Intl. Conf. Consumer Electronics, pp. 174-175, June 2001 by A. Yoneyama, H. Yanagihara, and Y. nakajima, an I-frame is determined by comparing several distance metrics between two consecutive frames with threshold values and then the distance between reference frames, parameter M in a GOP is determined as a function of the average motion estimation error and the average activity value of the GOP. Rate control in this solution is performed using MPEG-2 TM5 rate control algorithm.

A similar invention is disclosed in “Scene-context-dependent reference-frame placement for MPEG video coding,” IEEE Trans. Circuits and Syst. Video Technol, vol. 9, pp. 478-489, April 1999, by A. Y. Lan, A. G. Nguyen, and J.-N. Hwang, but this disclosure provides no rate control. Even with different distance metrics between frames, the solutions are similar in that the frame type of the current frame is determined considering frames only from the previous reference frame and the current frame. The frame with a large distance from a previous frame is identified as an I-frame. The frame that has the larger value of the accumulated distance after the previous reference frame is set to a P-frame. That is, all frames in a GOP are not considered globally to determine the positions of P-frames. Instead, the disclosure simply determines if a frame should be a P-frame or not by trading off coding efficiencies with incurred MCP errors when the frame is encoded as a B-frame.

A rate-distortion (R-D) optimized frame type decision method is disclosed in “Rate-distortion optimized frame type selection for MPEG encoding,” IEEE Trans. Circuits and Syst. Video Technol., vol. 7, pp. 501-510, June. 1997 by J. Lee and B. W. Dickinson. For a fixed GOP size equal to 15, the positions of P-frames and bit allocation are jointly optimized based on the dynamic programming. Although the optimal solution can be achieved, this solution suffers from excessive encoder complexity even with sub-optimal solutions.

The disclosures determine GOP structure by comparing frame parameters of one frame with either a threshold value or an immediate preceding or succeeding frame thereof, i.e., the GOP structures are determined on a frame by a frame basis, such that coding efficiency based thereon is not maximized. Thus there is a need for a method and apparatus determining a GOP structure adaptively at a GOP level and maximizing coding efficiency.

### BRIEF SUMMARY OF THE INVENTION

A detailed description is given in the following embodiments with reference to the accompanying drawings.

According to the invention, a method of determining a structure for a Group of Picture (GOP) is provided, comprising identifying an I-frame based on a correlation between two consecutive input frames to obtain the GOP size, and determining P-frames in the GOP based on the GOP rate.

According to another embodiment of the invention, a video encoder, determining a Group of Picture (GOP) structure is also provided, comprising an input frame buffer, an I-frame module and a P-frame module. The input frame buffer receives and stores input frames. The I-frame module coupled to the input frame buffer identifies an I-frame based on a correlation between two consecutive input frames to obtain the GOP size. The P-frame module coupled to the input frame buffer and the I-frame module, determines P-frames in the GOP having the GOP size based on the GOP rate.

According to yet another embodiment of the invention, a methods of controlling rate with adaptive GOP (Group of Picture) structure comprises generating low-resolution frames, identifying an I-frame based on a correlation coefficient between two consecutive low-resolution frames, determining P-frames jointly with frame-layer bit allocation such that GOP distortion D_{GOP} is minimized, thereby forming a GOP, and encoding all frames in the GOP.

### BRIEF DESCRIPTION OF THE DRAWINGS

The invention can be more fully understood by reading the subsequent detailed description and examples with references made to the accompanying drawings, wherein:

FIG. 1 is a block diagram of an exemplary video encoder according to the invention.

FIG. 2 is a flowchart of an exemplary method of adaptive GOP structure determination according to the invention, incorporating the video encoder in FIG. 1.

FIGS. 3a, 3b, and 3c show correlation coefficient C_{n, n-1} of two consecutive frames in several QCIF sequences.

FIG. 4 shows a GOP structure for uses in the method in FIG. 2.

FIGS. 5a, 5b, and 5c show the relationship between GOP rate R_{GOP} and S/Q.

FIG. 6 is a flowchart of an exemplary P-frame search method incorporated in step S208 of the method in FIG. 2.

FIG. 7 illustrates the frame positions of the GOP incorporating the method in FIG. 5.

FIG. 8 illustrates insertion of a new P-frame incorporating the method in FIG. 5.

FIG. 9 illustrates another exemplary method of adaptive P-frames assignment, incorporating the method in FIG. 2.

FIGS. 10a and 10b show the normalized GOP distortion D_{GOP} with respect to S·Q_{w}.

FIGS. 11a and 11b show the relationship of GOP rate R_{GOP} and square rooted Lagrange parameter √λ.

FIG. 12 is a flowchart of the joint P-frame selection and frame-layer bit allocation method according to the invention.

FIG. 13 is a flowchart of the frame encoding method according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

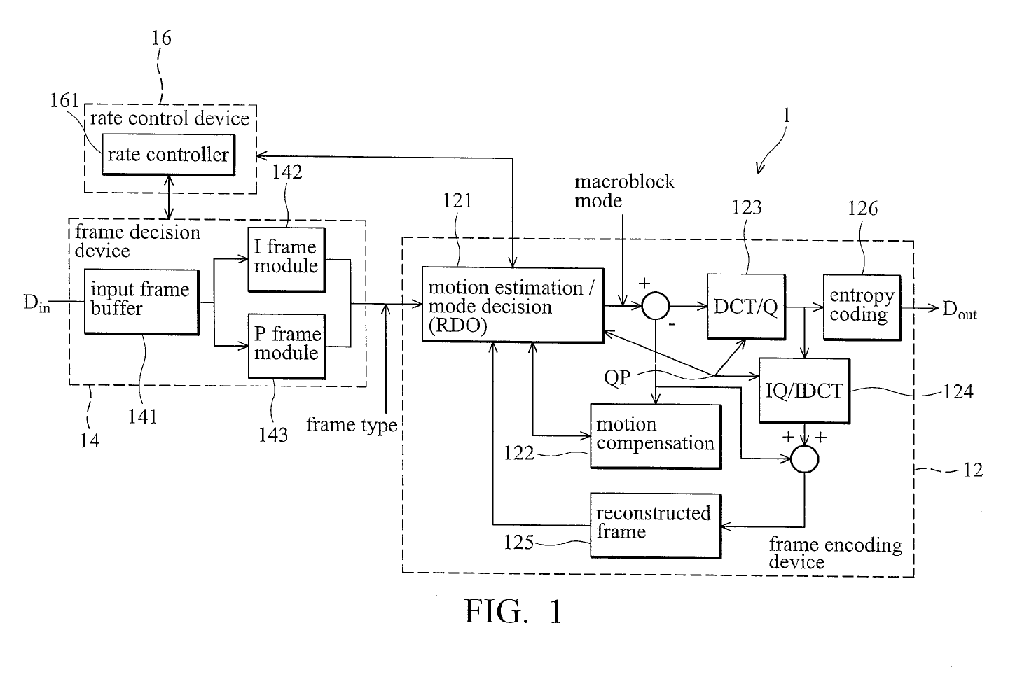

FIG. 1 is a block diagram of an exemplary video encoder according to the invention, comprising a frame encoding device 12, a frame type decision device 14 and a rate control device 16.

The frame type decision device 14 determines a GOP structure of a GOP adaptive to temporal variations in frames, and comprises an input frame buffer unit 141, an I-frame module 142 and a global P-frame module 143. The rate control device 16 comprising a rate controller unit 161 regulates bit allocation of each frame in the GOP to control output bitstream Dₒᵤₜ based on available channel bandwidth. The frame encoding device 12 encodes each frame based on the frame type determined in the frame type decision device 14, and comprises a R-D optimized motion estimation and mode decision (RDO) unit 121, a motion compensation unit 122, DCT/Q unit 123, IQ/IDCT unit 124, a reconstructed frame buffer unit 125 and an entropy coding unit 126.

When input data Dᵢₙ is encoded at fixed frame rate, several important coding parameters including the frame type of each frame, the macroblock mode of each macroblock in a frame, and the quantization parameter (QP) for a frame or a macroblock, are considered in encoder 1. The choice of these coding parameters is crucial to affect coding efficiency of encoder 1. In an embodiment, the frame type, the QP, and the macroblock mode are determined in the frame type decision device 14, the rate control device 16, and the RDO unit 121 of the frame encoding device 12 respectively. For simplicity, fixed quantization parameter QP is employed here.

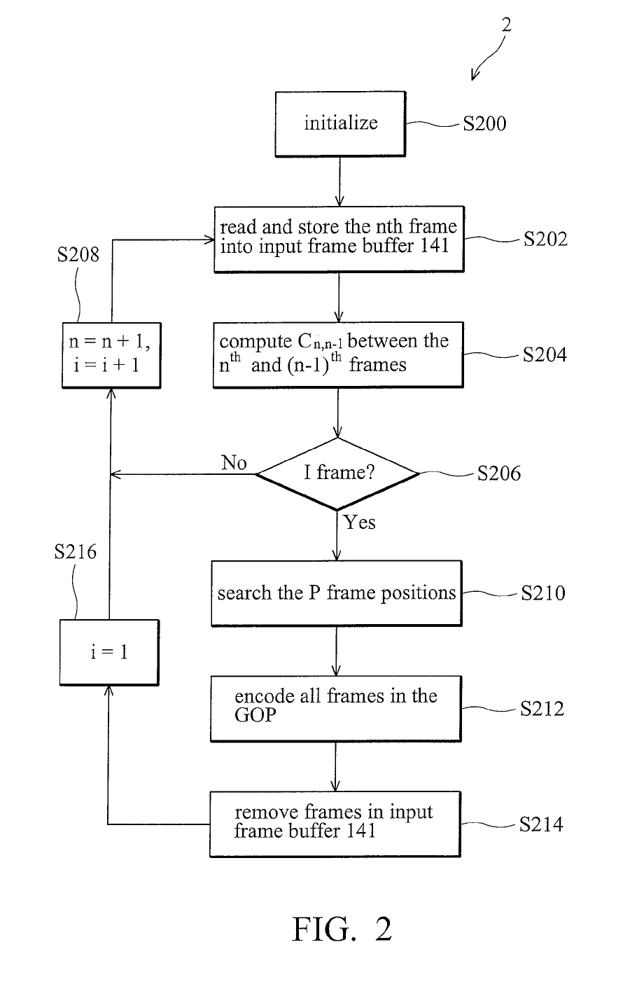

FIG. 2 is a flowchart of an exemplary method of adaptive GOP structure determination according to the invention, incorporating the video encoder in FIG. 1. Adaptive GOP structure method 2 comprises the I-frame module 142 identifying an I-frame based on a correlation between two consecutive input frames to obtain the GOP size, and the P-frame module 143 determining positions of P-frames in the GOP based on the GOP rate, such that the frame encoding device 12 encodes the GOP according to the GOP structure.

Referring to FIG. 2, adaptive GOP structure method 2 comprises initializing an I-frame in a GOP in step S200, reading and storing the subsequent n^{th} frame into the input frame buffer 141 in step S202, computing correlation coefficient C_{n, n-1} between the the n^{th} and (n−1)^{th} frames in step S204, examining if the n^{th} frame is an I-frame based on correlation coefficient C_{n, n-1} in step S206, and in step S208, updating input frame counter n and GOP-frame counter i if the n^{th} frame is not an I-frame. Adaptive GOP structure method 2 undergoes steps S202 to S208 until finding an I-frame, thereby determining the GOP size N_{GOP} (the distance between I-frames) of the GOP. Upon identification of an I-frame, the P-frame module searches and determines positions of all P-frames in the GOP based on GOP rate R_{GOP} thereof (step S210,), resulting in a frame sequence of P and B-frames constituting the GOP (referred to as a GOP structure). Next the frame encoding device 12 encodes all frames in the GOP according to the GOP structure (step S212), the frame type decision device 14 removes all except the last I-frame in the input frame buffer 141 (step S214) in the input frame buffer unit 141 and reinitializes GOP-frame counter i to 1 for the next GOP (step S216). Adaptive GOP structure method 2 loops steps S202 to S216 until completion of the method.

In step S200, initialization, a low-resolution frame is generated from an input original frame after low-pass filtering followed by downsampling and stored in the look-ahead buffer 141, the input frame buffer 141 receives and stores the first input frame (n=1, i=1) to be encoded as an I-frame. The input original frame is low-pass filtered by the average filter and down-sampled by 2 in both horizontal and vertical directions. Input frame counter n calculates the number of input frames Dᵢₙ, and GOP-frame counter i calculates the number of frames in the GOP. Then, input frame counter n and GOP-frame counter i are incremented to 2. In step S200, a low-resolution frame is generated from an input original frame after low-pass filtering followed by downsampling and stored in the look-ahead buffer in step S202.

In steps S202 the frame type decision device 14 reads and stores next input frame Dᵢₙ into the I-frame module 142, thereby computing correlation coefficient C_{n, n-1} between two consecutive input frames, the n^{th} and (n−1)^{th} frames in step S204, and obtaining the GOP size with GOP-frame counter i. In an example of computing correlation coefficient C_{n,n-1}, we first perform motion estimation for all 8×8 blocks in frame f_{2,n} with respect to previous frame f_{2,n-1} within the 4×4 search range. Correlation coefficient C_{n, n-1} compares how much the n^{th} and (n−1)^{th} frames resemble each other, and may be expressed by:

$${C}_{n , n - 1} = \frac{\begin{matrix}{\sum }_{x = 1}^{{W}_{2}} {\sum }_{y = 1}^{{H}_{2}} ( {f}_{2 , n} ( x , y ) - {\overline{f}}_{2 , n} ) \cdot \\ ( {f}_{2 , n - 1}^{d} ( x , y ) - {\overline{f}}_{2 , n - 1}^{d} )\end{matrix}}{\begin{matrix}\sqrt{{\sum }_{x = 1}^{{W}_{2}} {\sum }_{y = 1}^{{H}_{2}} ( {f}_{2 , n} ( x , y ) - {\overline{f}}_{2 , n} ) \cdot } \\ \sqrt{{\sum }_{x = 1}^{{W}_{2}} {\sum }_{y = 1}^{{H}_{2}} ( {f}_{2 , n - 1}^{d} ( x , y ) - {\overline{f}}_{2 , n - 1}^{d} )}\end{matrix}} \qquad ( 1 )$$

where C_{n,n-1} is the correlation between the two consecutive frames (n−1) and n, f_{2,n}(x,y) is (x,y)^{th} sample of the n^{th} frames, f^{d}_{2,n-1}(x, y) is (x,y)^{th} sample after motion estimation mapping to sample f₂ₙ(x,y), f̅_{2,n} and f̅^{d}_{2,n-1} are the average sample values of frames f_{2,n} and f^{d}_{2,n-1}, and W₂ and H₂ are the width and the height of the n^{th} low-resolution frame, respectively.

Correlation coefficient C_{n, n-1} can have a value between −1 and +1. Correlation coefficient C_{n, n-1} is very close to +1 when two consecutive frames are in a similar scene, whereas it is less than predetermined threshold TH_{C} during a scene change therebetween. Predetermined threshold TH_{C} is set to be 0.7. Since I-frame is encoded without motion compensation, the n^{th} frame is encoded as an I-frame upon detection of a scene change. Further, to ensure the accuracy of the frame encoding, the GOP size cannot exceed maximal GOP length L_{MAX} and an I-frame is encoded upon reaching thereto. In step S206, the I-frame module 142 compares GOP-frame counter i with maximal GOP length L_{MAX}, and correlation coefficient C_{n, n-1} with predetermined threshold TH_{C}. If GOP-frame counter i exceeds maximal GOP length L_{MAX}, or correlation coefficient C_{n, n-1} is less than predetermined threshold TH_{C}, the n^{th} frame is assigned as an I-frame, otherwise the n^{th} frame is a B-frame.

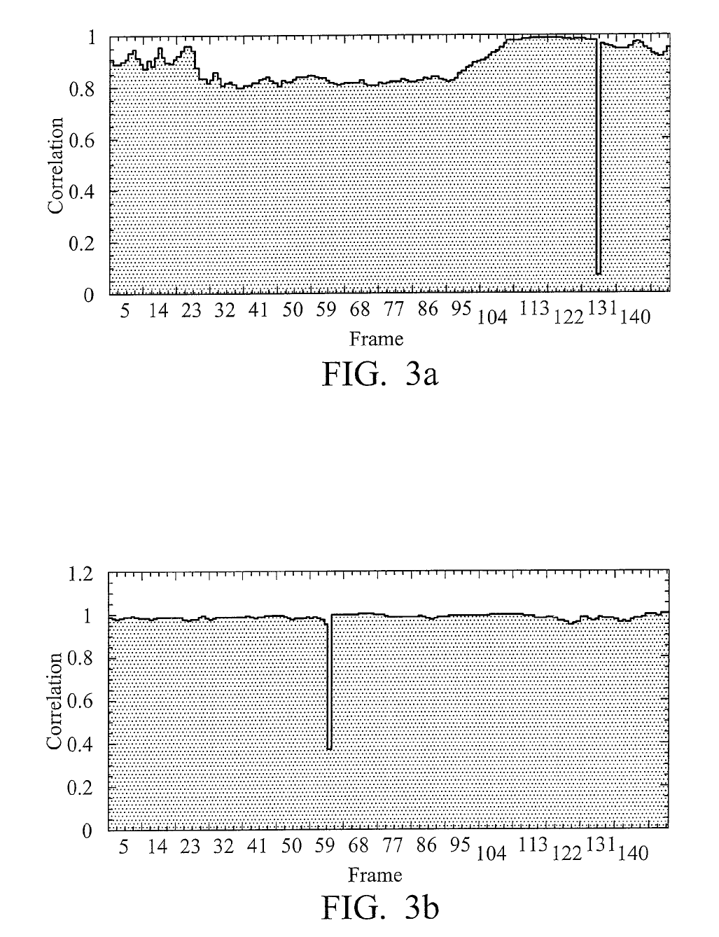

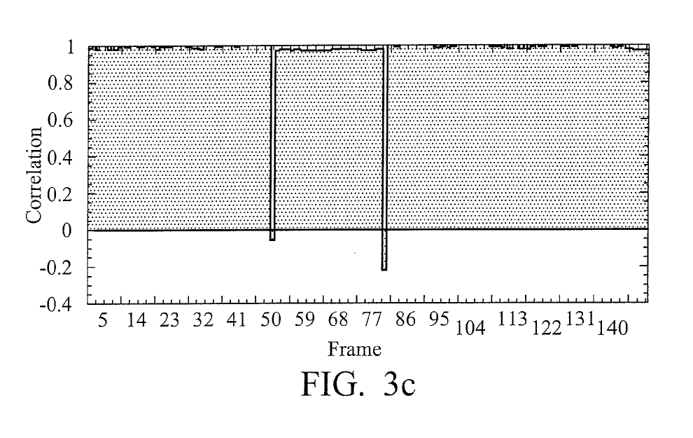

FIGS. 3a to 3c show correlation coefficient C_{n, n-1} of two consecutive frames in several QCIF sequences, incorporating the video encoder in FIG. 1 and the method in FIG. 2. Referring to FIGS. 3a to 3c, correlation coefficient C_{n, n-1} is around 0.4 to 0.5 during scene change detection, thus predetermined threshold TH_{C} is set to 0.4 in the exemplary embodiment. Predetermined maximal GOP length L_{MAX} is set to 30. If GOP-frame counter i exceeds 30 or correlation coefficient C_{n, n-1} is less than 0.4, then the n^{th} frame is encoded as an I-frame. Since the last I-frame (the n^{th} frame) corresponds to the beginning of the next GOP, the GOP size of the present GOP is (i−1).

If the n^{th} frame is not an I-frame, the I-frame module 142 increments input frame counter n and GOP-frame counter i by 1 in step S208, and continues to read and store the next frame in the input frame buffer 141 for the next computation of correlation coefficient C_{n, n-1}. If the I-frame module 142 identifies the n^{th} frame an I-frame, GOP structure determination method 2 then determines the frame sequence therein in step S210.

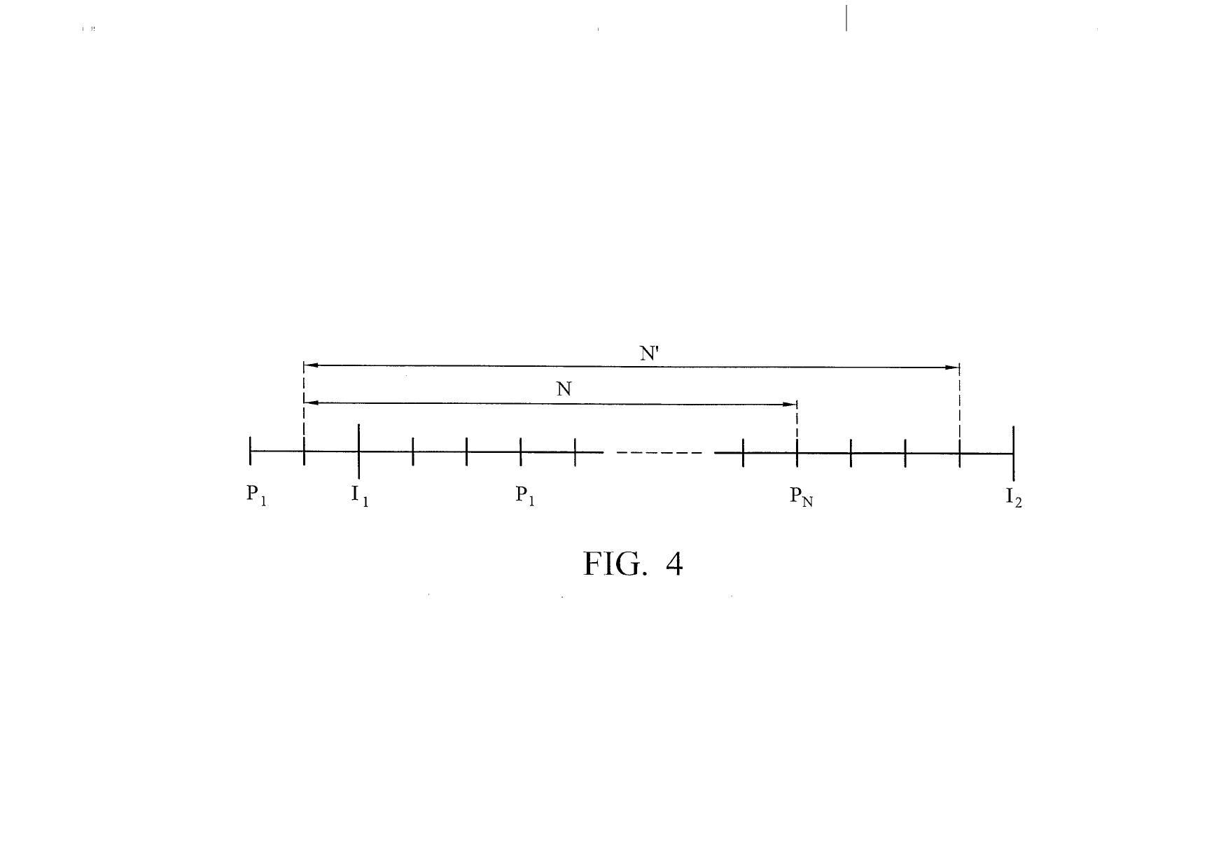

FIG. 4 shows a GOP structure for uses in the method in FIG. 2. I₁ represents the previous I-frame and I₂ represents the I-frame in step S206. Suppose that P₀ is the last encoded P-frame in a previous GOP and Pₙ is the last P-frame in a current GOP. Then, GOP size N is the distance between P₀ and Pₙ. However, since we do not know yet the type of each frame in the current GOP, we consider N′ frames (i.e., the frames between P₀ and I₂) for joint P-frame selection and frame-layer bit allocation.

Since the GOP size is provided upon identification of an I-frame, the P-frame module 143 of the frame type decision device 14 is ready to assign the P-frame positions in the GOP in step S210. The optimal positions of P-frames are found with bit-budget constrained rate control, when satisfying the following:

$$minimize {\sum }_{i = 1}^{{N}_{GOP}} {ω}_{i} \cdot {D}_{i} ( {t}_{i} , {q}_{i} ) subject to {\sum }_{i = 1}^{{N}_{GOP}} {R}_{i} ( {t}_{i} , {q}_{i} ) \leq {R}_{T , GOP} \qquad ( 2 )$$

where N_{GOP} is the GOP size,
Rᵢ(tᵢ, qᵢ) is rate of the i^{th} frame,
Dᵢ(tᵢ, qᵢ) is distortion of the i^{th} frame,
tᵢ is the frame type of the i^{th} frame in the GOP,
qᵢ is the quantization stepsize of the i^{th} frame in the GOP,
ωᵢ is a weighting factor corresponding to interdependencies between frames,
and is a larger value for reference frames, and
R_{T,GOP} is a target number of bits of the GOP.

Equation 2 optimizes the frame types and quantization stepsizes of all frames such that the weighted average distortion of the GOP is minimized while the bit-budget constraint to the GOP is satisfied. Equation 2 assumes frames are independent of each other to make the problem more tractable. Based on Lagrange optimization techniques, the above problem can be solved by minimizing Lagrange cost J:

$$J = {\sum }_{i = 1}^{{N}_{GOP}} {ω}_{i} \cdot {D}_{i} ( {t}_{i} , {q}_{i} ) + λ \cdot {\sum }_{i = 1}^{{N}_{GOP}} {R}_{i} ( {t}_{i} , {q}_{i} ) = {D}_{GOP} + λ \cdot {R}_{GOP} \qquad ( 3 )$$

where J is Lagrange cost, and
λ is Lagrange multiplier.
   The nonnegative Lagrange multiplier λ is determined such that the bit-budget constraint is satisfied. That is,

$${R}_{T , GOP} = {\sum }_{i = 1}^{{N}_{GOP}} {R}_{i} ( {t}_{i} , {q}_{i} ) \qquad ( 4 )$$

Here, it is assumed that each frame type is encoded using a corresponding constant quantization parameter QP. Therefore distortion Dᵢ(tᵢ,qᵢ) is substantially constant regardless of frame type, and Equation 3 is reduced to:

$$J = λ \cdot {\sum }_{i = 1}^{{N}_{GOP}} {R}_{i} ( {t}_{i} , {q}_{i} ) = λ \cdot {R}_{T , GOP} \qquad ( 5 )$$

Since the Lagrange multiplier is non-negative, only GOP rate R_{GOP} is considered to minimize Lagrange cost J. Consequently, the positions of P-frames are determined such that GOP rate R_{GOP} is minimized.

To facilitate the P-frame search process in step S208, a GOP-based rate model proportional to the complexity S of the GOP and reciprocally proportional to the quantization stepsize qᵢ of the GOP is deployed to determine GOP rate R_{GOP}, expressed by:

S=S_{I}+S_{P}+S_{B} (6)

where S_{I}, S_{P}, and S_{B} are the complexities of I, P and B-frames in the GOP respectively. When the i^{th} frame fᵢ is an I-frame, the complexity is computed from its low-resolution frame f_{2,i}. For example, for all 2×2 blocks in frame f_{2,i}, we perform intra prediction using the DC mode. Specifically, all sample values in a 2×2 block is estimated by the average value of 4 samples. The complexity of the I-frame S_{I} is computed as:

$${S}_{I} = {\sum }_{x = 1}^{{W}_{2}} {\sum }_{y = 1}^{{H}_{2}} \vert {f}_{2 , i} ( x , y ) - {f}_{2 , i}^{d} ( x , y ) \vert , \qquad ( 7 )$$

where W₂ and H₂ are the width and the height of the i^{th} low-resolution frame,
f_{2,i}(x,y) is (x,y)^{th} sample in the i^{th} frame, and
f^{d}_{2,n-1}(x, y) is the (x, y)^{th} intra predicted sample of f_{2,i}(x,y).

When the i^{th} frame fᵢ is a P-frame, suppose that gᵢ is its closest forward reference frame. Then, the complexity is computed from their low-resolution frames f_{2,i} and g_{2,i}. We first perform motion estimation for all 8×8 blocks in frame f_{2,i} with respect to forward reference frame g_{2,i} within the 8×8 search range. After that, let forward sample value g^{d}_{2,i}(x, y) be the sample value which current sample value f_{2,i}(x,y) maps to. Then, the complexity of the P-frame S_{P} is computed as:

$${S}_{P} = {\sum }_{∀ {f}_{i} ∈ P} {\sum }_{x = 1}^{{W}_{2}} {\sum }_{y = 1}^{{H}_{2}} \vert {f}_{2 , i} ( x , y ) - {g}_{2 , i}^{d} ( x , y ) \vert \qquad ( 8 )$$

where W₂ and H₂ are the width and the height of the i^{th} low-resolution frame, and
g^{d}_{2,i}(x, y) is the (x,y)^{th} sample value mapping to current sample value f_{2,i}(x,y) by forward motion vectors.

When the i^{th} frame fᵢ is a B-frame, suppose that gᵢ and hᵢ are its closest forward and backward reference frames, respectively. Then, the complexity is computed from their low-resolution frames f_{2,i}, g_{2,i} and h_{2,i}. We first perform motion estimation for all 8×8 blocks in f_{2,i} with respect to g_{2,i} and h_{2,i} within the 8×8 search range. The complexity of the B-frame S_{B} is computed as:

$${S}_{B} = {\sum }_{∀ {f}_{i} ∈ B} {\sum }_{x = 1}^{{W}_{2}} {\sum }_{y = 1}^{{H}_{2}} min ( \vert {f}_{2 , i} ( x , y ) - {g}_{2 , i}^{d} ( x , y ) \vert , \vert {f}_{2 , i} ( x , y ) - {h}_{2 , i}^{d} ( x , y ) \vert ) \qquad ( 9 )$$

where W and H are width and height of the i^{th} frame respectively, and
g^{d}_{2,i}(x, y) and h^{d}_{2,i}(x, y) are the (x,y)^{th} sample value mapping to the current sample f_{2,i}(x,y) by forward and backward motion vectors.

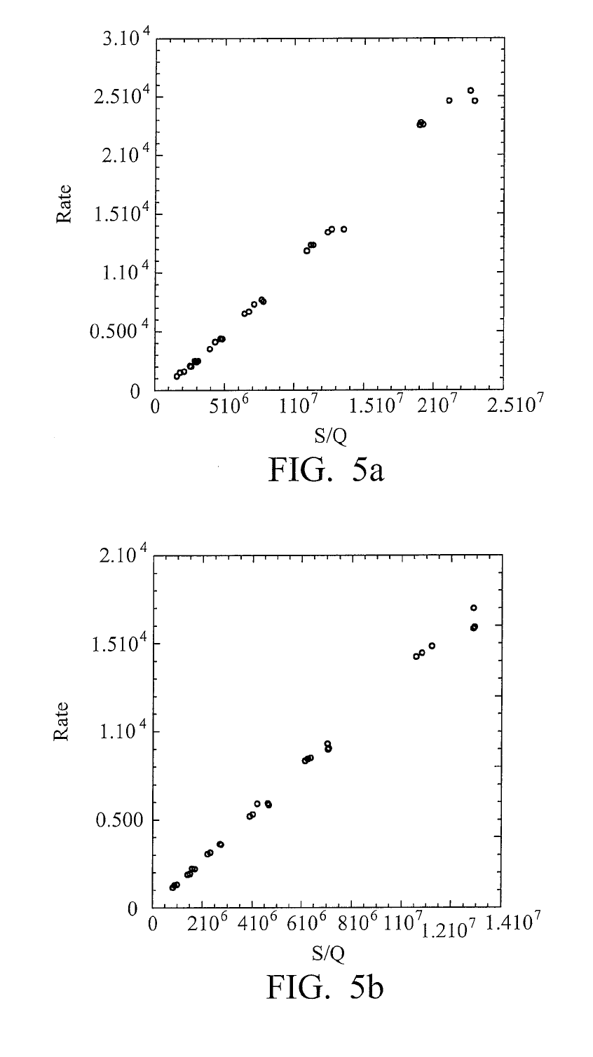

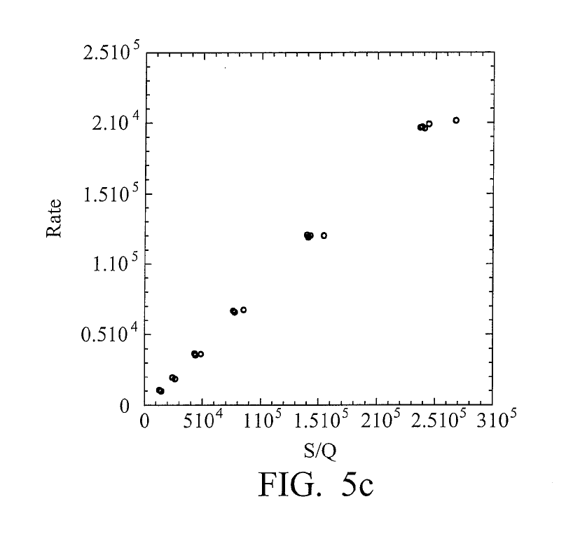

FIGS. 5a to 5c show the relationship between GOP rate R_{GOP} and S/Q for carphone, silent, and football frame sequences, incorporating the video encoder in FIG. 1 and the method in FIG. 2, in which S is the complexity of the GOP, and Q can be expressed as:

$$Q = {\sum }_{i = 1}^{{N}_{GOP}} {q}_{i} \qquad ( 10 )$$

where qᵢ is quantization stepsizes of i^{th} frame in the GOP, and
Q is a sum of all quantization stepsizes qᵢ in the GOP.

In FIGS. 5a to 5c, each frame sequence is encoded based on several GOP structures, including the GOP size N_{GOP} (the distance between I-frames) 15 with parameter M (the distance between P-frames) 2, 3 and 4, and GOP size N_{GOP} 30 with parameter M=4, 5, 6. Each GOP structure is encoded using quantization parameter QP=15, 20, 35, 30, 35 and 40 to estimate GOP rate R_{GOP} thereof.

Referring to FIGS. 5a to 5c, GOP rate R_{GOP} shows a linear relationship with S/Q regardless of GOP sizes and P-frame positions. GOP rate R_{GOP} is expressed by the following:

$${R}_{GOP} = {\sum }_{i = 1}^{N} {R}_{i} ( {t}_{i} , Q ( {q}_{i} ) ) = η \cdot \frac{S}{Q} , \qquad ( 11 )$$

where Q is the average quantization stepsize of a GOP.

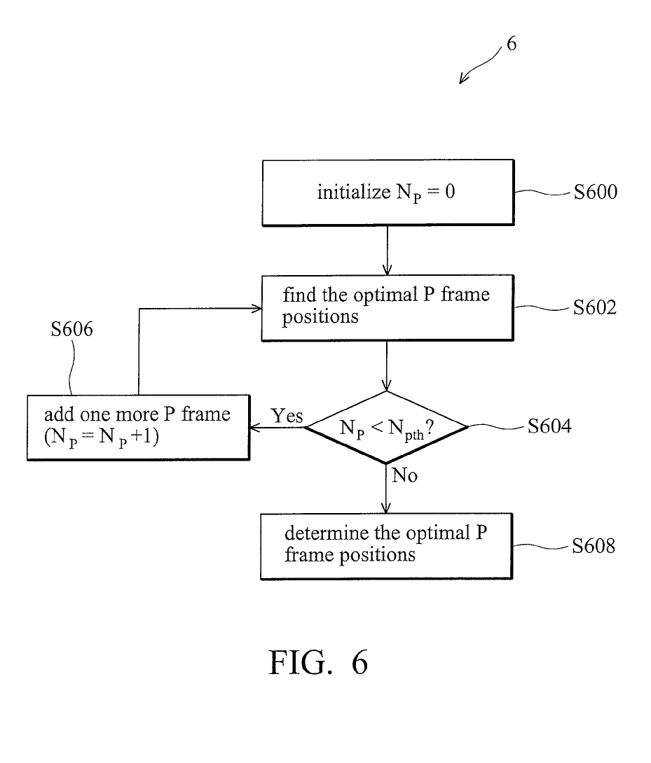

FIG. 6 is a flowchart of an exemplary P-frame search method incorporated in step S208 of the method in FIG. 2, determining the positions of P-frames such that GOP rate R_{GOP}, or equivalently S/Q, is minimized.

In step S600, the P-frame module 143 initializes a GOP with the GOP size N_{GOP} provided in step S206. The GOP includes an I-frame followed by B-frames throughout, and number of P-frames Nₚ is 0. The P-frame module 143 adjusts positions of P-frames (step S602), compares number of P-frames Nₚ with P-frame threshold Nₚₜₕ (step S604), replaces a B-frame in the GOP by a P-frame so that number of P-frame Nₚ is increased (Nₚ=Nₚ+1), if the number of P-frames Nₚ is less than P-frame threshold Nₚₜₕ (step S606), and determines positions of P-frames to minimize GOP rate R_{GOP} in step S608, if number of P-frames Nₚ is larger than or equal to P-frame threshold Nₚₜₕ.

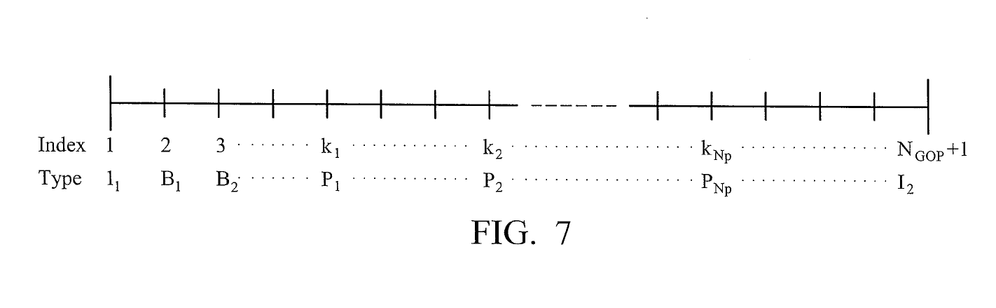

FIG. 7 illustrates the frame positions of the GOP incorporating the method in FIG. 6. The GOP comprises an I-frame followed by B and P-frames determined by the P-frame search method in FIG. 6. Referring to FIG. 7, the GOP having the GOP size N_{GOP} comprises Nₚ P-frames indexed by k₁, k₂, . . . , and k_{Np} corresponding to the 1^{st}, 2^{nd}, . . . , and Nₚ^{th} P-frame, denoted by P₁, P₂, . . . , and P_{Np}. Frame I₁ is the I-frame of the current GOP, and is encoded previously. Frame I₂ is the I-frame of the next GOP identified according to steps S206 by the I-frame module 142 of the frame type decision device 14.

For optimal positions of P-frames {P₁, P₂, . . . , P_{Np}} there exists a corresponding minimal (S/Q)_{Np}. In step S602, optimal positions {P₁, P₂, . . . , P_{Np}} are determined using a relaxation approach.

When Nₚ is 0, (S/Q)₀ is computed using Equations 6, 7, 9, 10 without the relaxation approach. After incrementing Nₚ in step S606, (S/Q)_{Np} is computed using the relaxation approach. The relaxation approach involves finding minimal GOP rate R_{GOP} by changing the n^{th} P-frame between positions of the (n−1)^{th} and (n+1)^{th} P-frames while keeping the other P-frames unchanged, iterating the finding step for each P-frame (1≦n≦Nₚ), and resulting in optimal positions {P₁, P₂, . . . , P_{Np}} with corresponding minimal (S/Q)_{Np}. For example, the relaxation approach finds minimal GOP rate R_{GOP} corresponding to P-frame P₁ by changing the 1^{st} P-frame between positions of index 1 and k₂ and keeping P-frames P₂ through P_{Np} unchanged, finds minimal GOP rate R_{GOP} corresponding to P-frame P₂ by changing the 2^{nd} P-frame between positions of index k₁ and k₃ and keeping P-frames P₁, P₃ through P_{Np} unchanged, iterates through the finding process for 1≦n≦Nₚ until there is no change in the positions of P-frames {P₁, P₂, . . . , P_{Np}}, and producing optimal positions {P₁, P₂, . . . , P_{Np}} with corresponding minimal (S/Q)_{Np}. Optimal positions {P₁, P₂, . . . , P_{Np}} and corresponding minimal (S/Q)_{Np} are stored for the next round of P-frame insertion in step S606.

In step S604, the P-frame module 143 determines if the number of P-frames Nₚ is less than P-frame threshold Nₚₜₕ (=N_{GOP}/2 in the embodiment). If so, another P-frame is added in step S606, and if not, optimal P-frame positions {P₁, P₂, . . . , P_{Np}, P_{Np+1}}are determined in step S608. Experiments with various frame sequences showed optimal coding efficiency is produced when the number of P-frames Nₚ is much less than N_{GOP}/2, resulting the choice of P-frame threshold Nₚₜₕ.

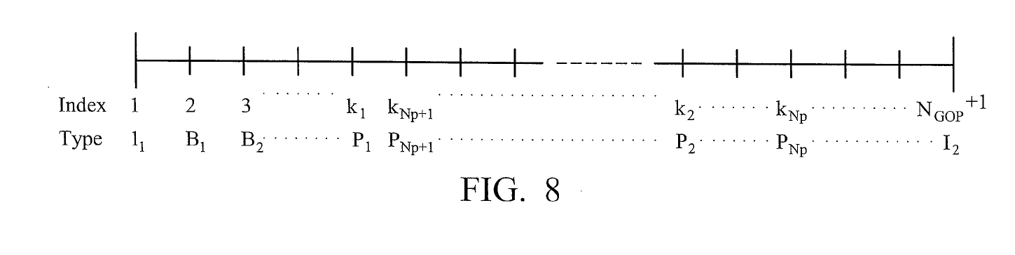

FIG. 8 illustrates insertion of a new P-frame incorporating the method in FIG. 6. In step S606, the P-frame module 143 locates the longest interval between two consecutive P-frames and replaces B-frames therebetween randomly with new P-frame P_{Np+1}. For example, P-frame P_{Np+1} is added between k₁^{th} and k₂^{th} frames in FIG. 8. In step S608, the P-frame module 143 determines optimal P-frame positions p′ as a set of P-frame positions {P₁, P₂, . . . , P_{Np}, P_{Np+1}} providing the minimal (S/Q)_{Np+1} by:

$${p}^{′} = {\text{arg} min}_{0 \leq Np \leq \frac{{N}_{GOP}}{2}} {( S / Q )}_{{N}_{P}} \qquad ( 12 )$$

At this point, GOP structure of the GOP is defined by the GOP size N_{GOP} and P-frame positions {P₁, P₂, . . . , P_{Np}} minimizing (S/Q)_{Np}, thus the frame encoding device 12 encodes all frames in the input frame buffer unit 141 accordingly in step S210. Then all frames except the last I-frame are removed from the input frame buffer unit 141 in step S212. Finally, in step S216, GOP-frame counter i is reinitialized to 1.

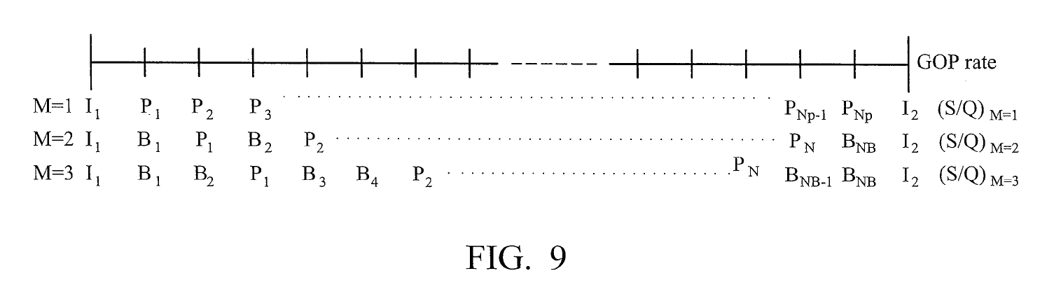

FIG. 9 illustrates another exemplary method of adaptive P-frame assignment, incorporating the method in FIG. 2.

With reference to FIG. 9, predetermined frame sequences characterized by the distance between P-frames are provided, represented by Parameter M. The predetermined frame sequence with M=1 comprises I-frame I₁ followed by P-frames through the end of a GOP. The predetermined frame sequence with M=2 comprises I-frame I₁ followed by a B-frame and a P-frame alternately through the end of a GOP. The predetermined frame sequence with M=3 comprises I-frame I₁ followed by two B-frames and a P-frame alternately in a GOP.

In step S208, the P-frame module 143 applies the predetermined frame sequence with M equaling 1, 2, and 3 to the GOP to produce first GOP SEQ1, second, GOP SEQ2 and third GOP SEQ3, generates corresponding GOP rate (S/Q)_{SEQ0}, (S/Q)_{SEQ1}, (S/Q)_{SEQ3} based on Equations 6-10, and selects an optimal GOP in first GOP SEQ1, second, GOP SEQ2 and third GOP SEQ3 corresponding to the maximum GOP rate in (S/Q)_{SEQ0}, (S/Q)_{SEQ1}, (S/Q)_{SEQ3}. Subsequently in step S210 the frame encoding device 12 encodes all frames in the input frame buffer 141 with the optimal GOP.

The proposed GOP rate and distortion models are verified by the following experiments. A set of different number of frames is grouped into a GOP and encoded into different GOP structure using different values of QP₁ and Lagrange parameter λ. To be more specific, 15 frames (N=15) or 30 frames (N=30) are grouped into a GOP. Then, the distance between reference frames M is set to 2, 3 and 4 for N=15 and 3, 4 and 5 for N=30. For each GOP structure, all frames in the GOP are encoded using each combination of QP₁ and Lagrange parameter A. We choose QP₁=15+3·n, where n=0, 1, . . . , 9, and several values of Lagrange parameter A for each QP₁ are used to allocate bits optimally to the frames based on the Lagrange optimization framework. To give an example, suppose that a set of frames is encoded into a particular GOP structure (i.e., tᵢ is known for all i=1, 2, . . . , N) using a particular choice of QP₁ and λ. The i^{th} frame is encoded as follows. The first stage of encoding is performed using QP₁ and rate Rᵢ(Q(qᵢ)) and distortion Dᵢ(Q(qᵢ)) from QP₁−Δ to QP₁+Δ, where Δ=3 are computed. After that, the residual signal of the i^{th} frame is encoded using QP₂, or qᵢ*, minimizing the following Lagrange cost:

$${q}_{i}^{*} = {\text{arg} min}_{{q}_{i} ∈ ( {QP}_{1} - Δ , {QP}_{1} + Δ )} {ω}_{i} \cdot {D}_{i} ( {t}_{i} , Q ( {q}_{i} ) ) + λ \cdot {R}_{i} ( {t}_{i} , Q ( {q}_{i} ) ) \qquad ( 13 )$$

where ωᵢ is a weighting factor of i^{th} frame, Dᵢ(tᵢ,Q(qᵢ)) is frame distortion of the i^{th} frame, Rᵢ(tᵢ,Q(qᵢ)) is frame rate of the i^{th} frame, tᵢ is frame type of the i^{th} frame; and λ is an Lagrange parameter.

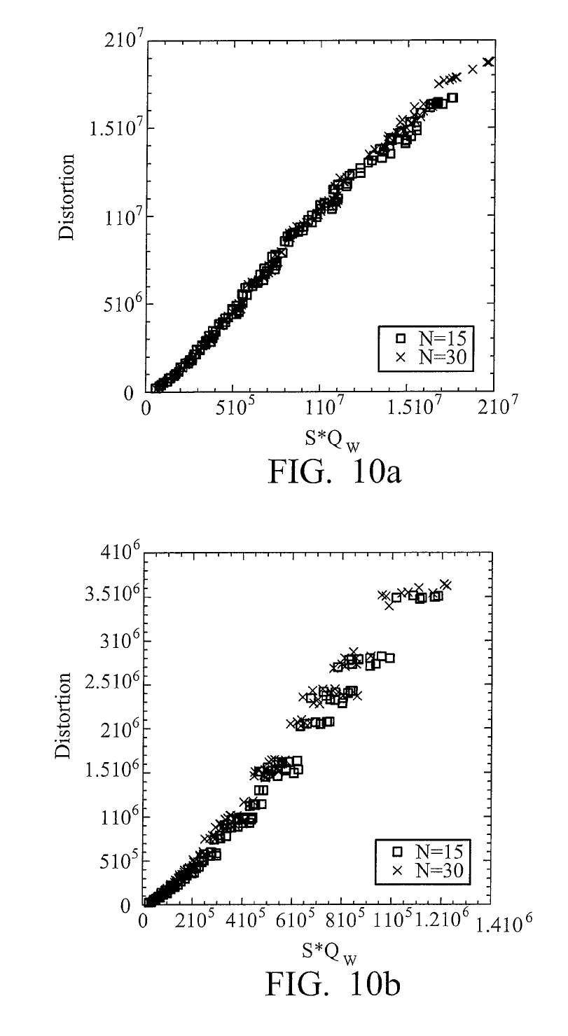

FIGS. 10a and 10b show the normalized GOP distortion D_{GOP} with respect to S·Q_{w}. GOP distortion D_{GOP} and S·Q_{w} can be modeled by Eq. 14:

$${D}_{GOP} = {\sum }_{i = 1}^{N} {ω}_{i} \cdot {D}_{i} ( {t}_{i} , Q ( {q}_{i} ) ) = ψ \cdot S \cdot {Q}_{ω} , \qquad ( 14 )$$

where Q_{w} is the weighted average quantization stepsize.

$${Q}_{ω} = \frac{1}{N} {\sum }_{i = 1}^{N} {ω}_{i} \cdot {Q}_{i} \qquad ( 15 )$$

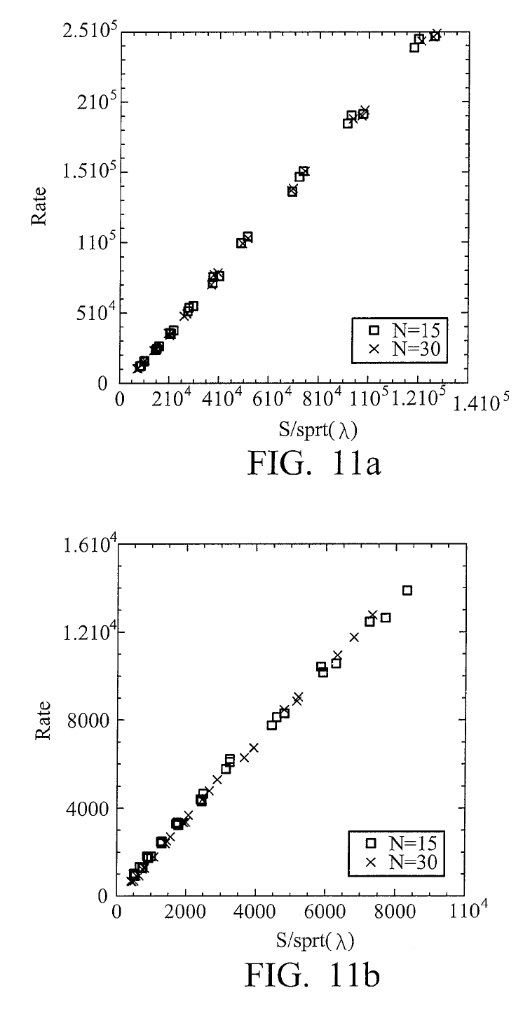

For first quantization parameter QP₁, if Lagrange parameter λ exceed a first threshold, we will get a constant rate since QP₂≦QP₁+Δ. All frames are quantized with QP₁+Δ. Similarly, if Lagrange parameter A is smaller than a second threshold, we will have another constant rate since QP₂≧QP₁−Δ. All frames are quantized with QP₁−Δ. Except for such cases, R_{GOP} can be estimated by the R−λ model. FIGS. 11a and 11b show the relationship of GOP rate R_{GOP} and square rooted Lagrange parameter √λ. When the average QP₁ is the same to the average QP₂, GOP rate R_{GOP} can be modeled by Eq. 16:

$${R}_{GOP} = ζ \cdot \frac{S}{\sqrt{λ}} \qquad ( 16 )$$

Referring to FIG. 4, given the target bits R_{T,N′} for N′ frames from P₀ and I₂, joint P-frame selection and frame-layer bit allocation is performed using the GOP rate and distortion models. Let G={G⁽¹⁾, G⁽²⁾, . . . , G⁽ⁿ⁾} be candidate GOP structures. The objective is to find the optimal GOP structure G*∈G that minimizes the GOP distortion when frame-layer bit allocation is performed based on the Lagrange optimization framework.

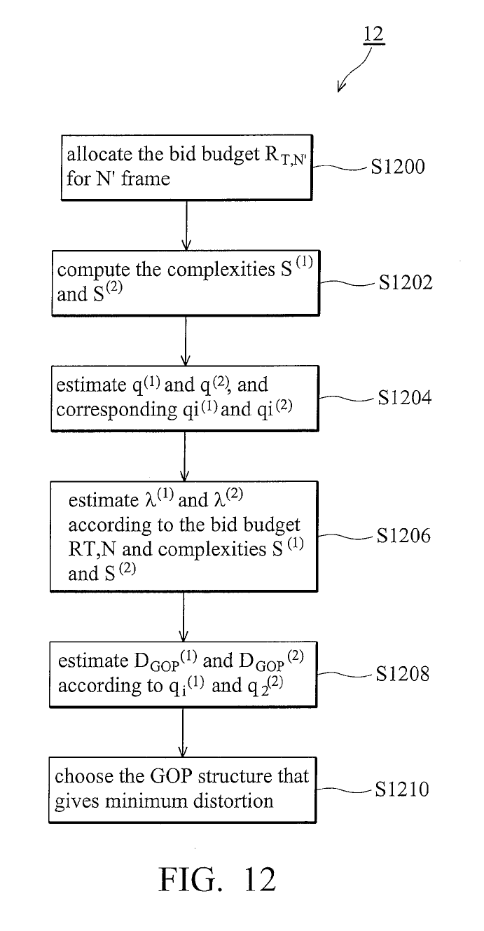

Without loss of generality, an example of joint P-frame selection and frame-layer bit allocation for two candidate GOP structures G={G⁽¹⁾, G⁽²⁾} is disclosed. FIG. 12 is a flowchart of the joint P-frame selection and frame-layer bit allocation method according to the invention, incorporating the frame notations in FIG. 4.

In step S1200, allocate the bit budget to N′ frames between P₀ and I₂ based on frame rate F and channel rate C, i.e.,

$${R}_{T , {N}^{′}} = {N}^{′} \cdot \frac{C}{F} + {R}_{0} \qquad ( 17 )$$

where R₀ is a feedback term which compensates for the difference between the target bits and the actual bits of the previous GOP.

In step S1202, compute the complexities S⁽¹⁾ and S⁽²⁾ for G⁽¹⁾ and G⁽²⁾ according to Eqs. 6˜9. Since different GOP structures have different dependency between frames, complexities S⁽¹⁾ and S⁽²⁾ are different.

In step S1204, for the target bit budget R_{T,N′}, determine average quantization parameters q⁽¹⁾ and q⁽²⁾ from complexities S⁽¹⁾ and S⁽²⁾ using Eq. 11. q⁽¹⁾ and q⁽²⁾ are the average quantization parameters corresponding to the average quantization stepsizes for G⁽¹⁾ and G⁽²⁾. From q^{(j)}, first quantization parameter QP₁ of the i^{th} frame is computed. Let qᵢ^{(j)} be first quantization parameter QP₁ of the i^{th} frame in the GOP structure G^{(j)}. Then, qᵢ^{(j)} is determined from average quantization parameter q^{(j)} as follows. If the i^{th} frame is an I or a P-frame:

$${q}_{i}^{( j )} = {q}^{( j )} - 2 \cdot \frac{{N}_{B}^{( j )}}{{N}^{′}} \qquad ( 18 )$$

where N_{B}^{(j)} is the number of B-frames in G^{(j)}. If the i^{th} frame is a B-frame, qᵢ^{(j)} is set to that of I and P-frames plus 2.

In step S1206, using Eq. 16, determine the Lagrange multipliers λ⁽¹⁾ and λ⁽²⁾ that meet the bit budget constraint according to complexities S⁽¹⁾ and S⁽²⁾. The frame-layer bit allocation for G^{(j)} can be done during frame encoding as long as λ⁽¹⁾ is known.

In step S1208, using Eq.14, GOP distortion D_{GOP}⁽¹⁾ and D_{GOP}⁽²⁾ are computed by encoding G⁽¹⁾ and G⁽²⁾ with first quantization parameter qᵢ⁽¹⁾ and qᵢ⁽²⁾ for i=1 , 2, . . . , N′

In step S1210, choose the GOP structure G that gives the minimum GOP distortion D*_{GOP} as the best GOP structure. Corresponding q* and λ* are stored for frame encoding.

The candidate GOP structures can be formed by several different ways. For example, we can consider all possible GOP structures as candidates. That is, full search over all possible GOP structures can be applied to find the best GOP structure. To reduce complexity, the fast search method in FIG. 9 can be applied. In this case, the number of candidates is reduced a lot. We may force a GOP to have the fixed distance between reference frames M within the GOP, as shown in FIG. 8. Then, we can form the candidate GOP structures with several values of M (e.g., M=2, 3, 4 and 5).

After joint P-frame selection and frame-layer bit allocation, all frames in the current GOP (i.e., N frames between P₀ and Pₙ) are encoded in step S210. I-frame I₂ and B-frames between Pₙ and I₂ are not encoded in the current GOP. Instead, I-frame I₂ and B-frames between Pₙ and I₂ are encoded in the next GOP.

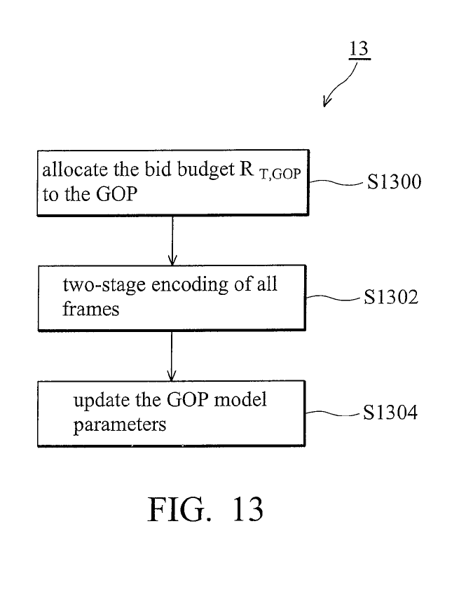

FIG. 13 is a flowchart of the frame encoding method according to the invention.

In step S1300, allocate the bit budget R_{T,GOP} to the current GOP based on frame rate F and channel rate C, i.e.,

$${R}_{T , GOP} = N \cdot \frac{C}{F} + {R}_{0} , \qquad ( 19 )$$

where R₀ is a feedback term which compensates for the difference between the target bits R_{T,GOP} and the actual bits R_{GOP} of the previous GOP. R_{T,GOP} is necessary for joint P-frame selection and frame-layer bit allocation of the next GOP in step S1200. For the next GOP, R₀ is the difference of R_{T,GOP} and R_{GOP} of the current GOP.

In step S1302, encode all frames in the current GOP by the two-stage encoding scheme. Suppose that the i^{th} frame is the target frame for encoding. We perform the rate distortion optimization process using QP₁ and then the residual signal is encoded by QP₂, which is qᵢ* that minimizes the Lagrange cost in Eq. 9.

In step S1304, update the GOP rate and distortion model parameter based on the least square approximation (LSA) method using the R-D information from previous 10 GOPs. The R-Q and D-Q model parameters are updated whenever all frames in a GOP are encoded. However, the R-λ model parameter is updated only when the difference between the average QP₂ and the average QP₁ is less than or equal to 1.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of determining a structure of a Group of Picture (GOP), comprising:
identifying an I-frame based on a correlation between two consecutive input frames to obtain the GOP size; and
determining a position of a P-frame in the GOP based on the GOP rate.

2. The methods of claim 1, wherein the identifying step comprises:
computing the correlation between the two consecutive input frames;
comparing the correlation with a predetermined threshold; and
setting the later frame of the two consecutive input frames as the I frame, when the correlation is less than the predetermined threshold.

3. The methods of claim 2, further comprising:
incrementing the GOP size by one, if the correlation is larger than or equal to the predetermined threshold;
resetting the GOP size to one if the correlation less than the predetermined threshold;
comparing the GOP size N_{GOP} with a maximum GOP length L_{MAX}; and
setting an I-frame when the GOP size exceeds the maximum GOP length L_{MAX}.

4. The method of claim 2, wherein the computing step comprises computing the correlation between the two consecutive input frames by:
$${C}_{n , n - 1} = \frac{\begin{matrix}{\sum }_{x = 1}^{{W}_{2}} {\sum }_{y = 1}^{{H}_{2}} ( {f}_{2 , n} ( x , y ) - {\overline{f}}_{2 , n} ) \cdot \\ ( {f}_{2 , n - 1}^{d} ( x , y ) - {\overline{f}}_{2 , n - 1}^{d} )\end{matrix}}{\begin{matrix}\sqrt{{\sum }_{x = 1}^{{W}_{2}} {\sum }_{y = 1}^{{H}_{2}} ( {f}_{2 , n} ( x , y ) - {\overline{f}}_{2 , n} ) \cdot } \\ \sqrt{{\sum }_{x = 1}^{{W}_{2}} {\sum }_{y = 1}^{{H}_{2}} ( {f}_{2 , n - 1}^{d} ( x , y ) - {\overline{f}}_{2 , n - 1}^{d} )}\end{matrix}} ,$$
where f_{2,n}(x,y) is (x,y)^{th} sample of n^{th} frames,
f^{d}_{2,n-1}(x, y) is (x,y)^{th} sample after motion estimation mapping to sample f_{2,n}(x,y);
f̅_{2,n} and f̅^{d}_{2,n-1} are average sample of frames f_{2,n} and f^{d}_{2,n-1}; and
W₂ and H₂ are the width and the height of the low-resolution frame.

5. The method of claim 1, wherein the GOP rate is:
$${R}_{GOP} = η \cdot \frac{S}{Q} ;$$
where R_{GOP} is the GOP rate;
S is the complexity of the GOP; and
Q is the average quantization stepsize of the GOP.

6. The method of claim 1, wherein the determining step comprises:
assigning the position of the P-frame to the GOP; and
estimating the GOP rate based on complexity of the GOP.

7. The methods of claim 6, wherein the assigning step comprises:
applying a first predetermined P-frame sequence to the GOP to provide a first GOP;
applying a second predetermined P-frame sequence to the GOP to provide a second GOP; and
the estimating step comprises:
estimating a first GOP rate based on complexity of the first GOP;
estimating a second GOP rate based on complexity of the second GOP; and
the method further comprises:
selecting an optimal GOP between the first and the second GOPs according to the first and the second GOP rates.

8. The methods of claim 6, wherein the assigning step comprises:
comparing the number of P-frames in the GOP with a P-frame threshold;
replacing a frame in the GOP with the P-frame, if the number of P-frames in the GOP is less than the P-frame threshold; and
the method further comprising:
restoring the replaced P-frame to a B-frame, if the GOP rate after the replacing step equals or exceeds the previous GOP rate.

9. The method of claim 8, wherein the GOP comprises 1^{st}, 2^{nd}, . . . , n^{th}, . . . , Np^{th} P-frames, the method further comprising changing a position of the n^{th} P-frame between positions of the (n−1)^{th} and (n+1)^{th} P-frames for each P-frame in the GOP and 1≦n≦Np, while maintaining the other P-frames, until a minimal GOP rate is located.

10. The method of claim 8, wherein the replacing step comprises replacing a frame in the longest interval between two succeeding P-frames in the GOP.

11. The method of claim 9, wherein the P-frame threshold is N_{GOP}/2, and the minimal GOP rate is:
$${p}^{′} = {arg min}_{0 \leq {N}_{p} \frac{{N}_{GOP}}{2}} {( S / Q )}_{{N}_{P}}$$
where p′ is the minimal GOP rate;
N_{P} is the number of P-frames in the GOP;
N_{GOP} is the number of frames in the GOP;
S is complexity of the GOP; and
Q is a sum of quantization stepsize of the GOP.

12. The methods of claim 6, further comprising summing complexities of I, P and B-frames in the GOP to obtain the complexity of the GOP:
S=S_{I}+S_{P}+S_{B};
where S is the complexity of the GOP; and
S_{I}, S_{P}, and S_{B} are the complexities of I, P and B-frames in the GOP respectively.

13. A method according to claim 12, wherein the complexities of I, P and B-frames are:
$${S}_{I} = {\sum }_{x = 1}^{{W}_{2}} {\sum }_{y = 1}^{{H}_{2}} \vert {f}_{2 , i} ( x , y ) - {f}_{2 , i}^{d} ( x , y ) \vert$$
$${S}_{P} = {\sum }_{∀ {f}_{i} ∈ P} {\sum }_{x = 1}^{{W}_{2}} {\sum }_{y = 1}^{{H}_{2}} \vert {f}_{2 , i} ( x , y ) - {g}_{2 , i}^{d} ( x , y ) \vert$$
$${S}_{B} = {\sum }_{∀ {f}_{i} ∈ B} {\sum }_{x = 1}^{{W}_{2}} {\sum }_{y = 1}^{{H}_{2}} min ( \vert {f}_{2 , i} ( x , y ) - {g}_{2 , i}^{d} ( x , y ) \vert , \vert {f}_{2 , i} ( x , y ) - {h}_{2 , i}^{d} ( x , y ) \vert )$$
where W₂ and H₂ are the width and the height of i^{th} low-resolution frame;
f_{2,i}(x,y) is (x,y)^{th} sample in the i^{th} frame;
f^{d}_{2,i}(x, y) is an intra predicted sample of f_{2,i}(x,y).
g^{d}_{2,i}(x, y) is (x,y)^{th} sample value mapping to the current sample
f_{2,i}(x,y) by a forward motion vector; and
h^{d}_{2,i}(x, y) is (x,y)^{th} sample value mapping to the current sample
f_{2,i}(x,y) by a backward motion vector

14. A video encoder, determining a structure of a Group of Picture (GOP), comprising:
an input frame buffer, receiving and storing input frames;
an I-frame module coupled to the input frame buffer, identifying an I-frame based on a correlation between two consecutive input frames to obtain the GOP size; and
a P-frame module coupled to the input frame buffer and the I-frame module, determining a position of a P-frame in the GOP based on the GOP rate.

15. The video encoder of claim 14, wherein the I-frame module computes the correlation between the two consecutive input frames, compares the correlation with a predetermined threshold, and sets the later frame of the two consecutive input frames as an I-frame, when the correlation is less than the predetermined threshold.

16. The video encoders of claim 15, wherein the I-frame module further increments the GOP size by one, if the correlation is larger than or equal to the predetermined threshold, resetting the GOP size to one, if the correlation is less than the predetermined threshold, compares the GOP size N_{GOP} with a maximum GOP length L_{MAX}, and sets an I-frame when the GOP size exceeds the maximum GOP length L_{MAX}.

17. The video encoder of claim 14, wherein the correlation is:
$${C}_{n , n - 1} = \frac{\begin{matrix}{\sum }_{x = 1}^{{W}_{2}} {\sum }_{y = 1}^{{H}_{2}} ( {f}_{2 , n} ( x , y ) - {\overline{f}}_{2 , n} ) \cdot \\ ( {f}_{2 , n - 1}^{d} ( x , y ) - {\overline{f}}_{2 , n - 1}^{d} )\end{matrix}}{\begin{matrix}\sqrt{{\sum }_{x = 1}^{{W}_{2}} {\sum }_{y = 1}^{{H}_{2}} ( {f}_{2 , n} ( x , y ) - {\overline{f}}_{2 , n} ) \cdot } \\ \sqrt{{\sum }_{x = 1}^{{W}_{2}} {\sum }_{y = 1}^{{H}_{2}} ( {f}_{2 , n - 1}^{d} ( x , y ) - {\overline{f}}_{2 , n - 1}^{d} )}\end{matrix}} ,$$
where f_{2,n}(x,y) is (x,y)^{th} sample of n^{th} frames,
f^{d}_{2,n-1}(x, y) is (x,y)^{th} sample after motion estimation mapping to sample f_{2,n}(x,y);
f̅_{2,n} and f̅^{d}_{2,n-1} are average sample of frames f_{2,n} and f^{d}_{2,n-1}; and
W₂ and H₂ are the width and the height of the low-resolution frame.

18. The video encoder of claim 14, wherein the GOP rate is:
$${R}_{GOP} = η \cdot \frac{S}{Q} ;$$
where R_{GOP} is the GOP rate;
S is the complexity of the GOP; and
Q is the average quantization stepsize of the GOP.

19. The video encoder of claim 14, wherein the P-frame module assigns the positions of P-frames to the GOP, and estimates the GOP rate based on complexity of the GOP.

20. The video encoders of claim 19, wherein the P-frame module applies a first predetermined P-frame sequence to the GOP to provide a first GOP, applies a second predetermined P-frame sequence to the GOP to provide a second GOP, estimates a first GOP rate based on complexity of the first GOP, estimates a second GOP rate based on complexity of the second GOP, and further selects an optimal GOP between the first and the second GOP according to the first and the second GOP rates.

21. The video encoders of claim 19, wherein the P-frame module compares the number of P-frames in the GOP with a P-frame threshold, replaces a frame in the GOP with the P-frame, if the number of P-frames in the GOP is less than the P-frame threshold, and further restores the replaced P-frame to a B-frame, if the GOP rate after the replacing step equals or exceeds the previous GOP rate.

22. The video encoder of claim 21, wherein the GOP comprises 1^{st}, 2^{nd}, . . . , n^{th}, . . . , Np^{th} P-frames, and the P-frame module further changes a position of the n^{th} P-frame between positions of the (n−1)^{th} and (n+1)^{th} P-frames for each P-frame in the GOP and 1≦n≦Np, while maintaining the other P-frames, until a minimal GOP rate is located.

23. The video encoder of claim 21, wherein the P-frame module replaces a frame in the longest interval between two succeeding P-frames in the GOP.

24. The video encoder of claim 22, wherein the P-frame threshold is N_{GOP}/2, and the minimal GOP rate is:
$${p}^{′} = {arg min}_{0 \leq {N}_{p} \frac{{N}_{GOP}}{2}} {( S / Q )}_{{N}_{P}}$$
where p′ is the minimal GOP rate;
N_{P} is the number of P-frames in the GOP;
N_{GOP} is the number of frames in the GOP;
S is complexity of the GOP; and
Q is a sum of quantization stepsize of the GOP.

25. The video encoders of claim 19, wherein the P-frame module further sums complexities of I, P and B-frames in the GOP to obtain the complexity of the GOP:
S=S_{I}+S_{P}+Sₙ;
where S is the complexity of the GOP; and
S_{I}, S_{P}, and S_{B} are the complexities of I, P and B-frames in the GOP respectively.

26. A video encoder according to claim 25, wherein the complexities of I, P and B-frames are:
$${S}_{I} = {\sum }_{x = 1}^{{W}_{2}} {\sum }_{y = 1}^{{H}_{2}} \vert {f}_{2 , i} ( x , y ) - {f}_{2 , i}^{d} ( x , y ) \vert$$
$${S}_{P} = {\sum }_{∀ {f}_{i} ∈ P} {\sum }_{x = 1}^{{W}_{2}} {\sum }_{y = 1}^{{H}_{2}} \vert {f}_{2 , i} ( x , y ) - {g}_{2 , i}^{d} ( x , y ) \vert$$
$${S}_{B} = {\sum }_{∀ {f}_{i} ∈ B} {\sum }_{x = 1}^{{W}_{2}} {\sum }_{y = 1}^{{H}_{2}} min ( \vert {f}_{2 , i} ( x , y ) - {g}_{2 , i}^{d} ( x , y ) \vert , \vert {f}_{2 , i} ( x , y ) - {h}_{2 , i}^{d} ( x , y ) \vert )$$
where W₂ and H₂ are the width and the height of i^{th} low-resolution frame;
f_{2,i}(x,y) is (x,y)^{th} sample in the i^{th} frame;
f^{d}_{2,i}(x, y) is an intra predicted sample of f_{2,i}(x,y).
g^{d}_{2,i}(x, y) is (x,y)^{th} sample value mapping to the current sample
f_{2,i}(x,y) by a forward motion vector; and
h^{d}_{2,i}(x, y) is (x,y)^{th} sample value mapping to the current sample
f_{2,i}(x,y) by a backward motion vector

27. A methods of controlling rate with adaptive GOP (Group of Picture) structure comprising:
generating low-resolution frames;
identifying an I-frame based on a correlation coefficient between two consecutive low-resolution frames;
determining P-frames jointly with frame-layer bit allocation such that GOP distortion D_{GOP} is minimized, thereby forming a GOP; and
encoding all frames in the GOP.

28. The methods of claim 27, wherein the identification comprising:
computing the correlation coefficients between the two consecutive low-resolution frames;
comparing the correlation coefficient with a pre-determined threshold TH_{C}; and
setting the later frame of the two consecutive input frames as the I-frame, when the correlation is less than the predetermined threshold TH_{C}.

29. The methods of claim 27, wherein the joint P-frame selection and frame-layer bit allocation comprising:
allocating a bit budget to the GOP;
providing candidate GOP structures of the GOP;
computing complexities according to the candidate GOP structures;
estimating average quantization parameters of the candidate GOP structures according to corresponding complexities;
estimating Lagrange multiplier of the candidate GOP structures according to the bit budget and the corresponding complexities;
estimating distortions of the candidate GOP structures according to the corresponding complexities; and
choosing the best GOP structures that provides the minimum GOP distortion.

30. The method according to claim 28, wherein the two consecutive low-resolution frames comprise n^{th} and (n−1)^{th} frames, the computation comprises:
performing motion estimation for all 8×8 blocks in the n^{th} frame f_{2,n} with respect to the (n−1)^{th} frame f_{2,n-1} within the 4×4 search range; and
estimating the correlation coefficient C_{n,n-1}, by:
$${C}_{n , n - 1} = \frac{\begin{matrix}{\sum }_{x = 1}^{{W}_{2}} {\sum }_{y = 1}^{{H}_{2}} ( {f}_{2 , n} ( x , y ) - {\overline{f}}_{2 , n} ) \cdot \\ ( {f}_{2 , n - 1}^{d} ( x , y ) - {\overline{f}}_{2 , n - 1}^{d} )\end{matrix}}{\begin{matrix}\sqrt{{\sum }_{x = 1}^{{W}_{2}} {\sum }_{y = 1}^{{H}_{2}} ( {f}_{2 , n} ( x , y ) - {\overline{f}}_{2 , n} ) \cdot } \\ \sqrt{{\sum }_{x = 1}^{{W}_{2}} {\sum }_{y = 1}^{{H}_{2}} ( {f}_{2 , n - 1}^{d} ( x , y ) - {\overline{f}}_{2 , n - 1}^{d} )}\end{matrix}} ;$$
where f_{2,n}(x,y) is (x,y)^{th} sample of n^{th} frames,
f^{d}_{2,n-1}(x, y) is (x,y)^{th} sample after motion estimation mapping to sample f_{2,n}(x,y);
f̅_{2,n} and f̅^{d}_{2,n-1} are average sample of frames f_{2,n} and f^{d}_{2,n-1}; and
W₂ and H₂ are the width and the height of the low-resolution frame.

31. The method according to claim 28, wherein TH_{C} pre-determined threshold is 0.7.

32. The method according to claim 29, wherein the bit budget R_{GOP} is:
$${R}_{GOP} = η \cdot \frac{S}{Q} ;$$
where S is the complexity of the candidate GOP structures; and
Q is the average quantization stepsize of the candidate GOP structure.

33. The method according to claim 29, wherein the GOP distortion D_{GOP} is:
D_{GOP}=ψ·S·Q_{ω};
where S is the complexity of the candidate GOP structure; and
Q_{w} is a weighted average quantization stepsize of the candidate GOP structure.

34. The method according to claim 29, wherein the bit budget R_{GOP} is:
$${R}_{GOP} = ζ \cdot \frac{S}{\sqrt{λ}}$$
where S is the complexity of the candidate GOP structure; and
λ is a Lagrange multiplier.

35. The method according to claim 34, wherein the complexity S of the candidate GOP structure is sum of complexities of I, P and B-frames in the GOP, i.e.,
S=S_{I}+S_{P}+S_{B}
where S_{I}, S_{P}, and S_{B} are the complexities of I, P and B-frames in the GOP, respectively.

36. The method according to claim 35, wherein the complexity of I-frame S_{I} is:
$${S}_{I} = {\sum }_{x = 1}^{{W}_{2}} {\sum }_{y = 1}^{{H}_{2}} \vert {f}_{2 , i} ( x , y ) - {f}_{2 , i}^{d} ( x , y ) \vert$$
where W₂ and H₂ are the width and the height of i^{th} low-resolution frame;
f_{2,i}(x,y) is (x,y)^{th} sample in the i^{th} frame; and
f^{d}_{2,i}(x, y) is an intra predicted sample of f_{2,i}(x,y).

37. The method according to claim 35, wherein the complexity of P-frame S_{P} is:
$${S}_{P} = {\sum }_{∀ {f}_{i} ∈ P} {\sum }_{x = 1}^{{W}_{2}} {\sum }_{y = 1}^{{H}_{2}} \vert {f}_{2 , i} ( x , y ) - {g}_{2 , i}^{d} ( x , y ) \vert$$
where W₂ and H₂ are the width and the height of i^{th} low-resolution frame;
f_{2,i}(x,y) is (x,y)^{th} sample in the i^{th} frame; and
g^{d}_{2,i}(x, y) is (x,y)^{th} sample value mapping to the current sample
f_{2,i}(x,y) by a forward motion vector.

38. The method according to claim 35, wherein the complexity of B-frame S_{B} is:
$${S}_{B} = {\sum }_{∀ {f}_{i} ∈ B} {\sum }_{x = 1}^{{W}_{2}} {\sum }_{y = 1}^{{H}_{2}} min ( \vert {f}_{2 , i} ( x , y ) - {g}_{2 , i}^{d} ( x , y ) \vert , \vert {f}_{2 , i} ( x , y ) - {h}_{2 , i}^{d} ( x , y ) \vert )$$
where W₂ and H₂ are the width and the height of i^{th} low-resolution frame;
f_{2,i}(x,y) is (x,y)^{th} sample in the i^{th} frame;
g^{d}_{2,i}(x, y) is (x,y)^{th} sample value mapping to the current sample f_{2,i}(x,y) by a forward motion vector; and
h^{d}_{2,i}(x, y) is (x,y)^{th} sample value mapping to the current sample
f_{2,i}(x,y) by a backward motion vector.

39. The method according to claim 27, wherein the encoding comprising:
performing a rate distortion optimization (RDO) process for i^{th} frame, for all i=1, 2, . . . , N, using first quantization parameter QP₁;
encoding residual signal of the i^{th} frame using second quantization parameter QP₂, which is qᵢ* that minimizes the following Lagrange cost q*:
$${q}_{i}^{*} = {arg min}_{{q}_{i} ∈ ( {QP}_{1} - Δ , {QP}_{1} + Δ )} {ω}_{i} \cdot {D}_{i} ( {t}_{i} , Q ( {q}_{i} ) ) + λ \cdot {R}_{i} ( {t}_{i} , Q ( {q}_{i} ) )$$
where ωi is a weighting factor of i^{th} frame;
Dᵢ(tᵢ,Q(qᵢ)) is frame distortion of the i^{th} frame;
Rᵢ(tᵢ,Q(qᵢ)) is frame rate of the i^{th} frame;
tᵢ is frame type of the i^{th} frame; and
λ is an Lagrange parameter.
